(19) United States
(12) Patent Application Publication
(10) Pub. No.: US 2023/0359542 A1
(43) Pub. Date: Nov. 9, 2023

(54) HANDLING DATA GAPS IN SEQUENTIAL DATA

(71) Applicant: INTERNATIONAL BUSINESS MACHINES CORPORATION, ARMONK, NY (US)

(72) Inventors: Xi Yang, Apex, NC (US); Larisa Shwartz, Greenwich, CT (US); Ruchi Mahindru, Elmsford, NY (US); Yu Deng, YORKTOWN HEIGHTS, NY (US); Ian Manning

(21) Appl. No.: 17/662,083

(22) Filed: May 5, 2022

(51) Int. Cl. G06F 11/34; G06K 9/62

(52) U.S. Cl. CPC G06F 11/3447; G06K 9/6267; G06F 2201/805; G06F 2201/835

(57) ABSTRACT

A method, a computer program product, and a computer system handle a data gap in sequential data. The method includes receiving the sequential data for a period of time. The method includes selecting the data gap in the sequential data at a timestamp. The method includes determining a sliding window associated with the data gap based on the timestamp for a duration of time. The sliding window includes dependent data from which the data gap depends. The method includes, as a result of the dependent data of the sliding window including at least one window data gap, generating extracted patterns based on the dependent data to mask the at least one window data gap. The method includes determining a prediction to fill the data gap using a prediction model that takes as input modified data based on the dependent data and the extracted patterns.

### BACKGROUND

The exemplary embodiments relate generally to sequential data, and more particularly to utilizing all available data to fill a data gap in the sequential data.

When data is transferred from one device to another, a data gap may form due to a variety of reasons. A data gap may be an instance when data should be present but is missing. Data gaps are ubiquitous and usually inevitable in real-world data despite measures in place to prevent them. For example, there may be system glitches resulting in network packet loss, outages, etc. More specifically, for sequential streams collected over time, the data acquisition equipment may go offline or may be incorrectly configured such that corresponding timestamps during these periods may be missing from the data collection. The corresponding timestamps during these periods may therefore create data gaps in the collection.

### SUMMARY

The exemplary embodiments disclose a method, a computer program product, and a computer system for handling a data gap in sequential data. The method comprises receiving the sequential data for a period of time. The method comprises selecting the data gap in the sequential data, the data gap being at a timestamp. The method comprises determining a sliding window associated with the data gap. The sliding window is based on the timestamp for a duration of time preceding the timestamp. The sliding window includes dependent data indicative of information that the data gap depends. The method comprises, as a result of the dependent data of the sliding window including at least one window data gap, generating extracted patterns based on the dependent data to mask the at least one window data gap. The method comprises determining a prediction to fill the data gap using a prediction model that takes as input modified data based on the dependent data and the extracted patterns.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a data gap filling system 100, in accordance with the exemplary embodiments.

FIG. 2 depicts an exemplary flowchart of a method 200 illustrating the operations of a data handling server 130 of the data gap filling system 100 in handling a data gap in sequential data, in accordance with the exemplary embodiments.

FIG. 3 depicts an exemplary scenario of the data gap filling system 100 filling a data gap in sequential data, in accordance with the exemplary embodiments.

FIG. 4 depicts an exemplary block diagram depicting the hardware components of the data gap filling system 100 of FIG. 1, in accordance with the exemplary embodiments.

FIG. 5 depicts a cloud computing environment, in accordance with the exemplary embodiments.

FIG. 6 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method, computer program product, and system for handling a data gap in sequential data, more specifically for time-series base sequential data. The exemplary embodiments provide a framework in which to utilize any available information to fill the data gap. Even under scenarios where the information being relied upon to fill the data gap also has data gaps, the framework according to the exemplary embodiments may determine extracted features that serve as patterns in the information. In this manner, the exemplary embodiments model the handling of the data gap as a forecasting problem. Key benefits of the exemplary embodiments may include utilizing all available information and preventing omission of portions of the available information in filling the data gap where the framework is configured to be flexible to fit a wide range of scenarios without prior assumptions. Detailed implementation of the exemplary embodiments follows.

With regard to information technology systems, data in such systems are typically multi-variate (e.g., via monitoring, different metrics may be collected for an e-commerce system where several traces may be collected from different components at the application level to collectively represent the health of the system). Conventional approaches have provided a variety of mechanisms for dealing with gaps in sequential data. For example, conventional approaches may simply neglect the information that is contained in the data gaps for further processing purposes. However, such an approach only utilizes usable data and cannot take advantage of all the available data. In another example, conventional approaches may impute data gaps such as with a univariable-based mechanism or a multivariable-based mechanism. However, the univariable-based mechanism cannot capture interactions among different variables while the multivariable-based mechanism relies on assumptions over a data distribution but cannot handle scenarios where the gap is over all or a subset of variables. In a further example, conventional approaches may arbitrarily apply metrics or other assumptions such as utilizing a masked segment having a length that must follow a geometric distribution with a predetermined mean. However, these conventional approaches must rely on these limitations of the process to perform further processing operations.

The exemplary embodiments introduce a framework configured to utilize all available information that has been received to determine how to fill a data gap. As will be described in further detail below, the framework provides a masking mechanism to mask data gaps that may be present in the information used to fill the data gap. The framework utilizes a sliding window of time relative to a timestamp of the data gap and extracts features as patterns so that all the available information is utilized in filling the data gap. As significant data mining techniques require an absence of data gaps for application thereof, the exemplary embodiments mask these data gaps such that the data mining techniques may be applied as intended.

The exemplary embodiments are described with regard to sequential data that is received from a data source. Accordingly, any reference to data being analyzed according to the exemplary embodiments may relate to sequential data. Those skilled in the art will understand that sequential data is directed to a set of data that is dependent on other points of data (e.g., a timeseries). However, the use of sequential data is only for illustrative purposes. As those skilled in the art will understand, the exemplary embodiments may be utilized and/or modified with determining or extrapolating data based on other available information from data that was successfully received.

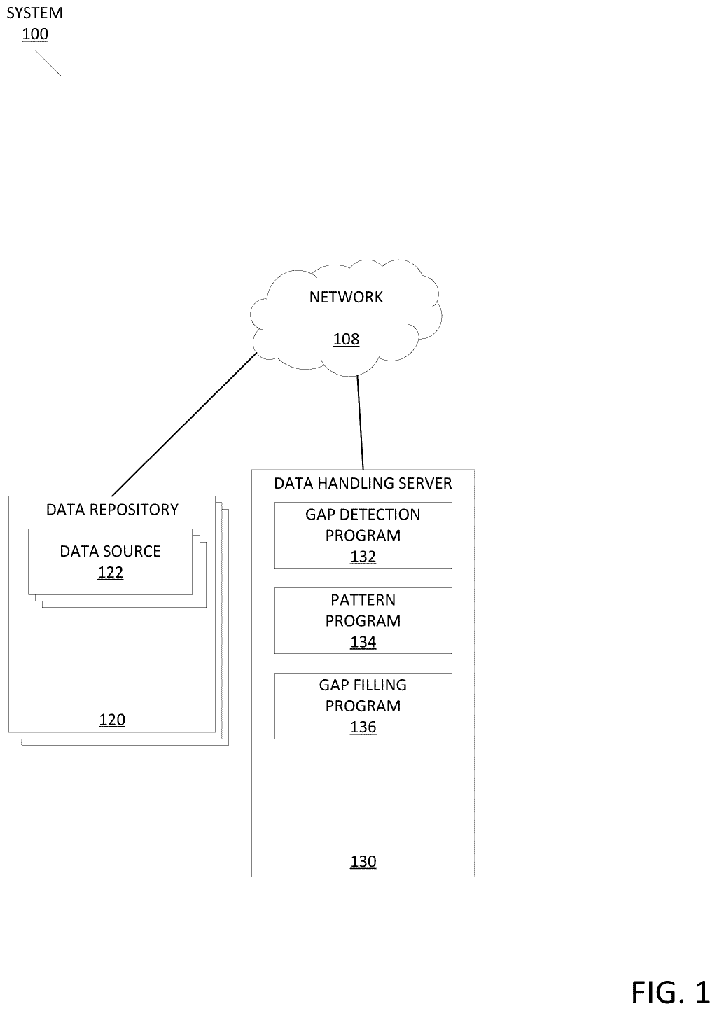

FIG. 1 depicts a data gap filling system 100, in accordance with the exemplary embodiments. According to the exemplary embodiments, the data gap filling system 100 may include one or more data repositories 120 and a data handling server 130, which may all be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the data gap filling system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices. For example, the network 108 may also represent direct or indirect wired or wireless connections between the components of the data gap filling system 100 that do not utilize the network 108.

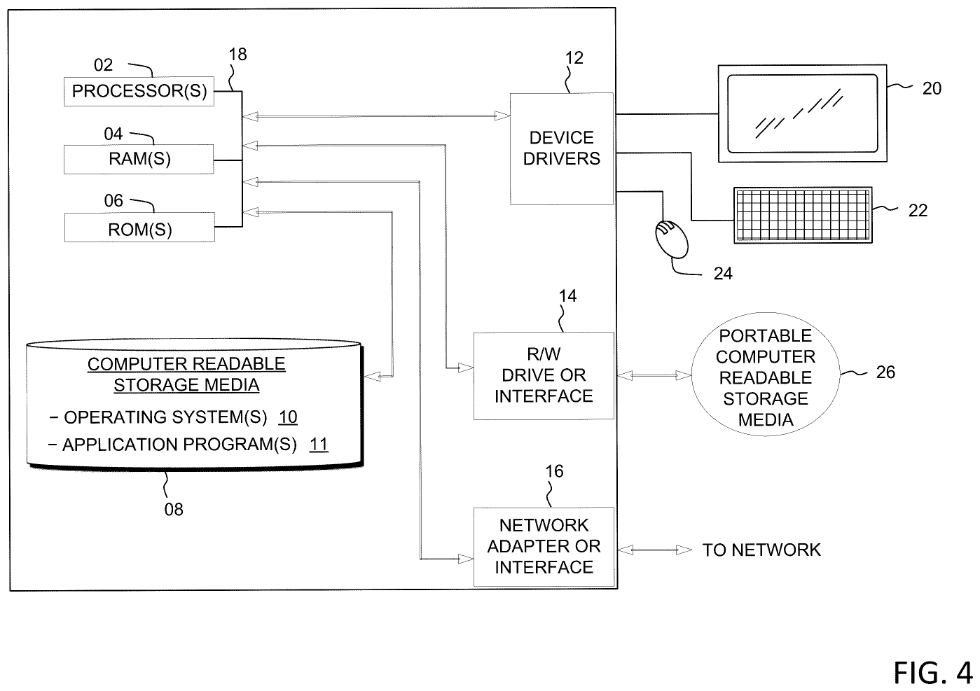

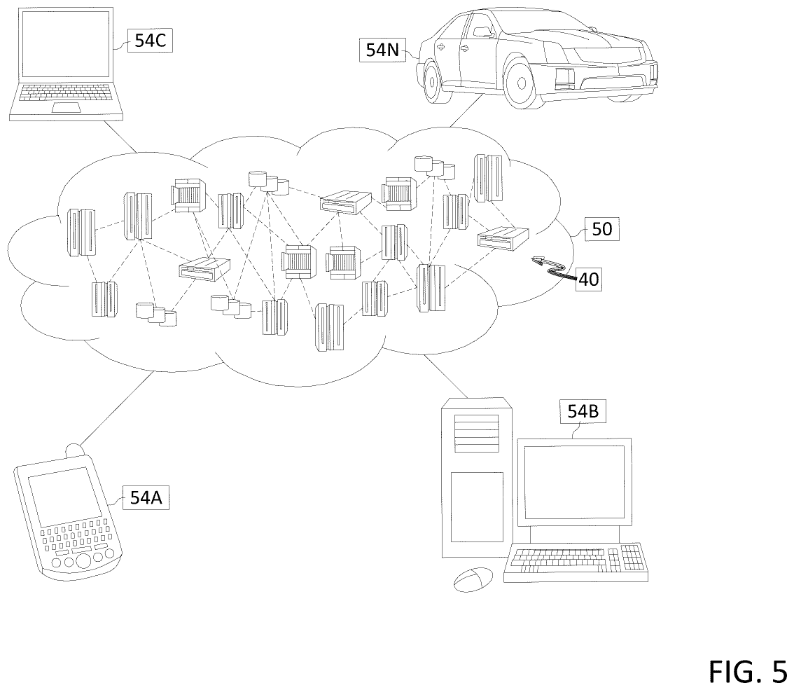

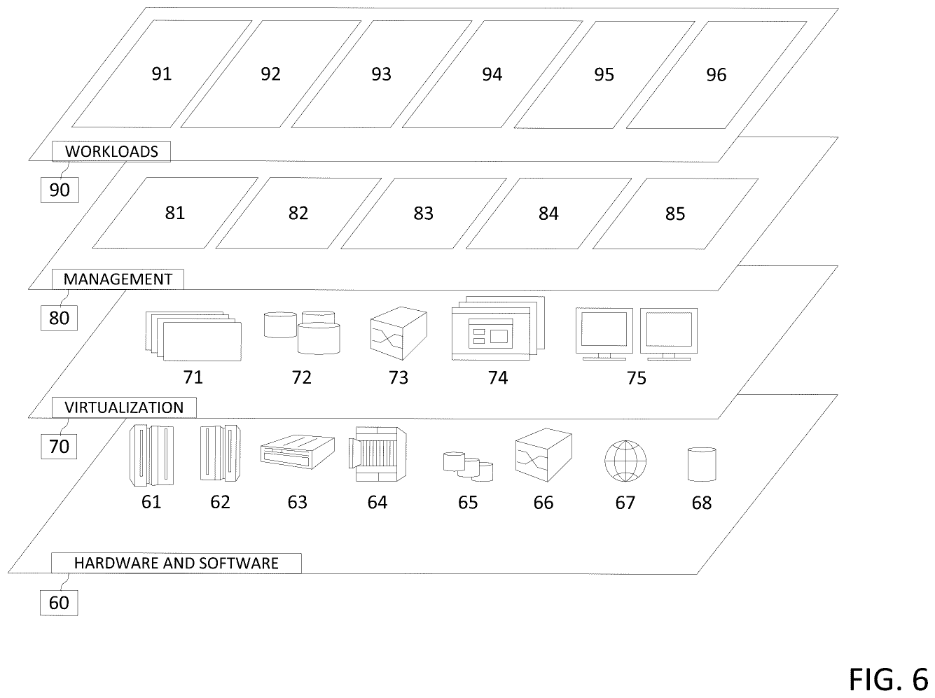

In the exemplary embodiments, the data repository 120 may include one or more data sources 122 from which data is stored and may be transmitted to another device and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the data repository 120 is shown as a single device, in other embodiments, the data repository 120 may be comprised of a cluster or plurality of electronic devices, in a modular manner, etc., working together or working independently. The data repository 120 is described in greater detail as a hardware implementation with reference to FIG. 4, as part of a cloud implementation with reference to FIG. 5, and/or as utilizing functional abstraction layers for processing with reference to FIG. 6.

In the exemplary embodiments, the data handling server 130 may include a gap detection program 132, a pattern program 134, and a gap filling program 136, and be in a communicative relationship with the data repository 120 and the data sources 122. The data handling server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the data handling server 130 is shown as a single device, in other embodiments, the data handling server 130 may be comprised of a cluster or plurality of computing devices, working together, or working independently. While the data handling server 130 is also shown as a separate component and as a server, in other embodiments, the operations and features of the data handling server 130 may be incorporated with a device that is processing the sequential data. The data handling server 130 is described in greater detail as a hardware implementation with reference to FIG. 4 (e.g., data processing according to the exemplary embodiments being performed by processor 02), as part of a cloud implementation with reference to FIG. 5 (e.g., the device 110 according to the exemplary embodiments being represented by the desktop computer 54B), and/or as utilizing functional abstraction layers for processing with reference to FIG. 6 (e.g., workload layer 90 including data gap processing 96 according to the exemplary embodiments).

In the exemplary embodiments, the gap detection program 132 may be a software, hardware, and/or firmware application configured to determine a presence of a data gap in the sequential data. As will be described in further detail below, the gap detection program 132 may identify a data gap to be filled (e.g., a selected data gap) and may identify and determine data gaps that may be present in the information used to fill the selected data gap. In identifying the data gaps that may be present in the information used to fill the selected data gap, the gap detection program 132 may further be configured to determine a sliding window over which the information was received. As noted above, the data being processed may be sequential data that is received over a period of time where each data unit or variable may have a respective timestamp. Based on the timestamp of the selected data gap, the gap detection program 132 may determine the size and location of the sliding window relative to the selected data gap.

In the exemplary embodiments, the pattern program 134 may be a software, hardware, and/or firmware application configured to determine extracted features as patterns in the information used to fill the selected data gap. The patterns may be determined via a Random Convolutional Kernel Transform (ROCKET) algorithm with a masking mechanism to essentially hide the data gaps in the information used to fill the selected data gap. The ROCKET algorithm may be a multi-variate time-series classification model that takes partial data and determine extracted features through convolution with kernels that generate feature maps from which the features are extracted. In comparison to univariate-based approaches, the ROCKET algorithm may capture the interactions across multi-variables. In comparison to other multi-variate based approaches, the ROCKET algorithm may provide flexibility to fit different scenarios without requiring prior assumptions. The randomness of the ROCKET algorithm may be incorporated via the kernel size, weight values having a normal distribution, bias having a uniform distribution, dilation having an exponential scale up to input length, padding having a binary decision, etc. The masking mechanism may provide a mechanism by which a sequence-processing layer may be instructed that select timestamps in an input are missing and therefore should be skipped when processing that data. The exemplary embodiments may incorporate the ROCKET algorithm and/or other algorithms from which patterns are determined from available data. For illustrative purposes, the exemplary embodiments will be described with reference to utilizing the ROCKET algorithm to at least initially extract features as patterns.

In the exemplary embodiments, the gap filling program 136 may be a software, hardware, and/or firmware application configured to receive an input of the information either as the information itself (e.g., when data gaps are absent) or in a modified manner comprising the patterns for portions of the information having data gaps (e.g., when data gaps are present). Based on this input, the gap filling program may learn a prediction model such that this input results in predicting the selected data gap and thereby filling this selected data gap. As those skilled in the art will understand, the exemplary embodiments may utilize any prediction model (e.g., a regression model) based on a variety of technologies such as machine learning, artificial intelligence, etc., and may also utilize neural networks such as an artificial neural network, a recursive neural network, a convolutional neural network, etc. The gap filling program 136 may also be configured with a validation mechanism that may incorporate a feedback operation. As will be described in further detail below, the gap filling program 136 may validate the results of filling the data gaps using any of a variety of validation mechanisms. For example, the results of the validation may be measured against an acceptable threshold for subsequent processing of the data (e.g., a determination of whether the subsequent processing is capable of being performed through filling the data gaps). As a result of the validation not meeting the acceptable threshold, the gap filling program 136 may utilize the feedback operation by determining a recommendation to modify the process in filling the data gaps. For example, the gap filling program 136 may determine a different feature extraction method, a different method for prediction to fill the data gaps, an estimate for floor and/or ceiling accuracy, etc. This process may be iterative until the validation operation is satisfied.

As an overview, the data handling server 130 may utilize the gap detection program 132, the pattern program 134, and the gap filling program 136 in a plurality of phases. In a first phase, the data handling server 130 may perform an unsupervised operation for pattern identification (e.g., using the ROCKET algorithm). Using the learnt patterns via the extracted features whether the patterns are normal or abnormal, the data handling server 130 may perform a feature extraction from the missing data to compute a feature vector for a timestamp for which a data gap is to be filled. The data handling server 130 may subsequently utilize a regression model to generate forecasted missing values that is used in filling the data gaps. In this manner, the data handling server 130 may utilize the final output to fill data gaps that may be implemented in a variety of applications such as anomaly detection, trend detection, forecasting, etc.

The data sources 122 and/or the data handling server 130 may be configured with data exchange devices such that data from the data sources 122 may be transmitted to another device such as the data handling server 130. According to the exemplary embodiments, the data from the data sources 122 may be streamed to the data handling server 130 as sequential data. In another exemplary embodiment, the data from the data sources 122 may be streamed to a further device (not shown) which may be forwarded to the data handling server 130 for the features thereof to be provided. The data used as the input for the exemplary embodiments may be collected in logs through which metrics may be identified using a metrics extractor where the metrics may be categorized as a labelled series or an unlabelled series. During any transmission of data (e.g., from the data sources 122, from the further device, etc.), any of the data exchange devices either from the source (e.g., the data sources 122), the medium (e.g., the network 108), or the destination (e.g., the data handling server 130) may experience an event that creates a data gap in the sequential data. The resulting data gap may be for a part of the variables in the sequential data or may be for overall variables in the sequential data. In either type, as will be described in further detail below, the exemplary embodiments may perform operations to utilize the information with one or more data gaps in filling a selected data gap in the sequential data.

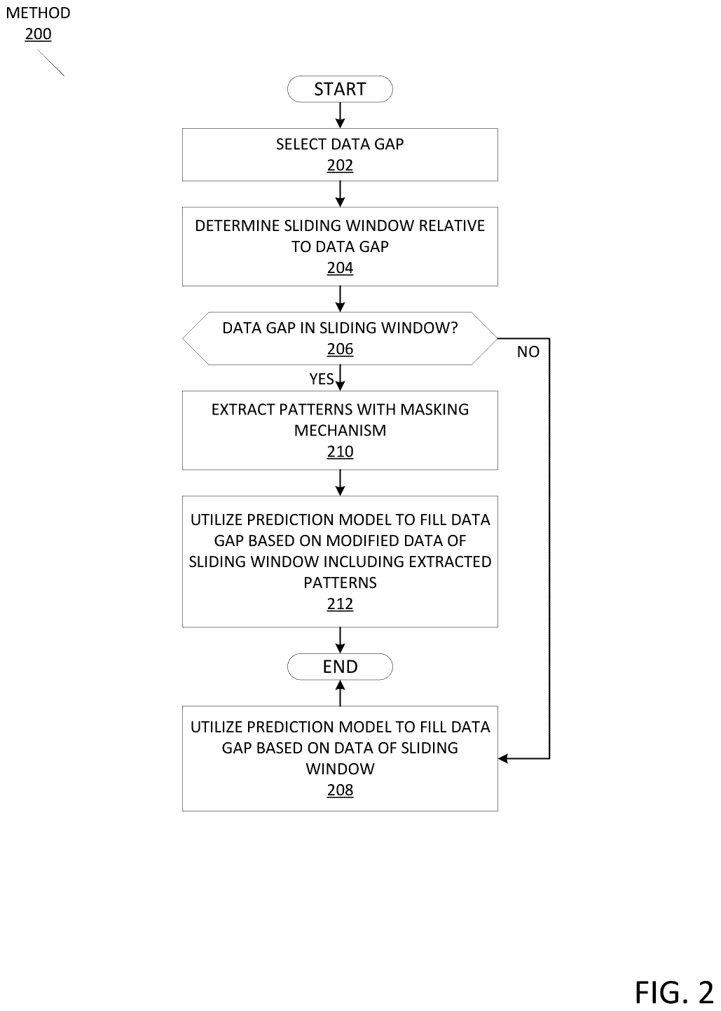

FIG. 2 depicts an exemplary flowchart of a method 200 illustrating the operations of a data handling server 130 of the data gap filling system 100 in handling a data gap in sequential data, in accordance with the exemplary embodiments. The method 200 may relate to operations that are performed by the gap detection program 132, the pattern program 134, and the gap filling program 136. The method 200 will be described from the perspective of the data handling server 130.

The data handling server 130 may select a data gap in the sequential data (step 202). The data handling server 130 may receive the sequential data in a variety of manners. For example, the data handling server 130 may receive the sequential data directly from the data source 122 or indirectly via another device that has received the sequential data directly from the data source 122. The data handling server 130 may also process the sequential data at a variety of times. For example, the data handling server 130 may process the sequential data as the sequential data is being received (e.g., after a predetermined amount of time has passed that the data has been received). In another example, the data handling server 130 may process the sequential data upon the entire sequence has been received. Once the sequential data has been received for processing, the data handling server 130 may identify one or more data gaps that may be present in the sequential data. The data handling server 130 may further select a data gap in the sequential data to be filled utilizing the features of the exemplary embodiments. The selected data gap may refer to a particular variable that is missing (e.g., either as part of the variable or the overall variable) or may refer to a specific data unit within the particular variable.

The data handling server 130 may determine a sliding window comprising data for information used in filling the selected data gap (step 204). The sliding window may represent any portion of the sequential data to which the selected data gap may have a dependence. Accordingly, the data corresponding to the sliding window may include information that may be used to fill the selected data gap. In an exemplary embodiment, a sliding window Xₜ may be defined relative to a timestamp t of the selected data gap. For example, the sliding window Xₜ may be defined as {x_{t-w+1}, . . . , xₜ₋₁} where w may be a dependence factor specific to the sequential data indicative of a time period extending prior to the timestamp t for dependent data to which the selected data gap depends.

The data handling server 130 may determine whether the data in the sliding window includes at least one data gap (decision 206). The data gap in the sliding window may also be referred to as a window data gap. As a result of determining the sliding window, the data handling server 130 may utilize the data falling in the sliding window to fill the data gap. As data gaps may or may not occur in the sliding window, the data handling server 130 may determine subsequent operations based on whether there is at least one data gap in the sliding window.

As a result of the data not including a data gap (decision 206, “NO” branch), the data handling server 130 may utilize a prediction model to fill the selected data gap based on the data in the sliding window (step 208). With the data in the sliding window being complete with no data gaps, the prediction model may utilize all the information of this data and output a prediction to fill the selected data gap using any technique as one skilled in the art will understand. In this manner, the data handling server 130 may take the data of the sliding window directly.

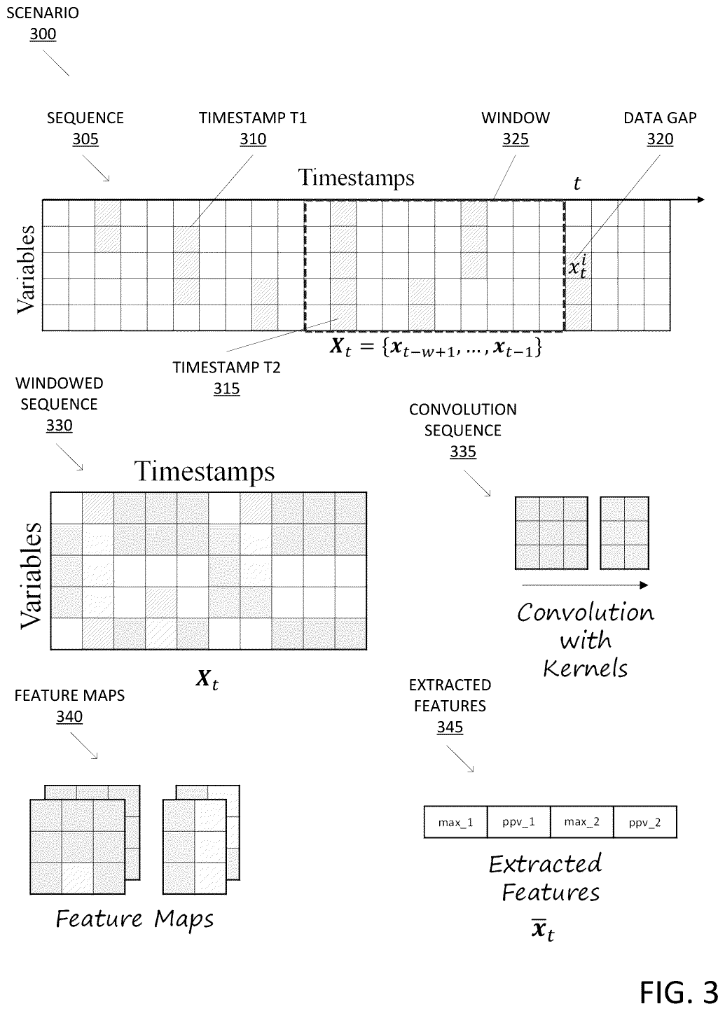

As a result of the data including at least one data gap (decision 206, “YES” branch), the data handling server 130 may extract patterns via the ROCKET algorithm with a masking mechanism (step 210). Rather than taking the data in the sliding window directly, the data handling server 130 may modify the data in the sliding window to account for the at least one data gap. According to the exemplary embodiments, the data handling server 130 may be configured with the ROCKET algorithm that takes the data in the sliding window that includes the at least one data gap. The ROCKET algorithm may extract features in the form of extracted patterns of the data in the sliding window. In an exemplary implementation, the ROCKET algorithm may incorporate a ridge classification where the ROCKET algorithm generates features from sequences through a plurality (e.g., a substantial number) of random convolutional kernels and uses a ridge regression classifier to model the generated features. In this manner, the ROCKET algorithm may be equipped with a masking mechanism that masks the at least one data gap. The ROCKET algorithm may output data that essentially appears to not have any data gap. The ROCKET algorithm will be described in further detail with regard to FIG. 3.

In masking the data gap, different machine learning models such as the ROCKET algorithm may extract patterns among multi-variables and across different timestamps. According to the exemplary embodiments, the ROCKET algorithm may accept the missing data in the data gaps as an input by introducing the masking mechanism that masks the missing data from the convolutional results. Taking the extracted patterns as an input, the data handling server 130 may train a regression model to forecast the missing data from which a “completed” data collection may be provided to enable other machine learning algorithms to be applied to conduct deeper analysis of the data collection.

The data handling server 130 may utilize the prediction model to fill the selected data gap based on modified data in the sliding window including the extracted patterns (step 212). With the data in the sliding window being modified with the extracted patterns, the prediction model may utilize this modified data and output a prediction to fill the selected data gap using any technique as one skilled in the art will understand.

The method 200 is described above in an illustrative process. The method 200 may be performed with further operations. As described above, the data handling server 130 may incorporate a validation mechanism that may use a feedback loop. When incorporating such a mechanism, the method 200 may be modified so that results from the prediction model to fill data gaps are validated (e.g., measured against an acceptable threshold). The method 200 may determine whether the results are acceptable to proceed with further operations or whether further results are required. As a result of further results being required, the method 200 may include a determining operation for recommending and insight generation where a different feature extraction method may be employed, a different method for prediction may be employed, an estimate for floor/ceiling accuracy is used, etc.

FIG. 3 depicts an exemplary scenario 300 of the data gap filling system 100 filling a data gap in sequential data, in accordance with the exemplary embodiments. As illustrated in the scenario 300, a sequence 305 of sequential data may be received by the data handling server 130. As shown in FIG. 3, the sequence 305 is represented as a plurality of data units for variables (y-axis) over time measured in timestamps (x-axis). The sequence 305 is also shown to include data gaps represented as shaded data units. For example, at timestamp t1 310, the sequence 305 may include a data gap for a part of the variable. In another example, at timestamp t2 315, the sequence 305 may include a data gap for the overall variable.

In processing the sequence 305, the data handling server 130 may identify the various data gaps. The data handling server 130 may also select one of the data gaps to fill. For example, the data handling server 130 may select data gap 320 which is represented as xₜⁱ occurring at timestamp t for data unit i of the corresponding variable. The data gap 320 may be a part of the variable as other data units of the variable have data that was received.

In selecting the data gap 320, the data handling server 130 may determine a sliding window 325 for the data gap 320. As described above, the sliding window 325 may be a period of time relative to the timestamp t of the data gap 320. In a particular implementation, the sliding window 325 may be a period of time that extends immediately prior to the timestamp t. That is, a duration of time corresponding to the sliding window 325 may immediately precede the timestamp t. However, in other implementations, the sliding window 325 may be any period of time in which the data thereof includes information on which the data gap 320 depends. As shown, the sliding window 325 may extend from a first time to a second time and include all the data units covered by the window such as described above (e.g., Xₜ={x_{t-w+1}, . . . , xₜ₋₁}).

The data handling server 130 may process the sliding window 325 to determine whether there is at least one data gap. As shown, the sliding window 325 may have a plurality of data gaps including parts of the variable and the overall variable. As a result of the presence of at least one data gap, the data handling server 130 may utilize the features of the exemplary embodiments.

The data handling server 130 may utilize the data having at least one data gap in the sliding window 325 represented as a windowed sequence 330. As described above, for the scenario 300 where the sliding window 325 includes at least one data gap, the data handling server 130 may utilize the ROCKET algorithm. Accordingly, the data handling server 130 may utilize a convolution sequence 335 in which to perform a convolution with kernels as one skilled in the art will understand according to the description of the exemplary embodiments. As a result of the convolution with kernels using the convolution sequence 335, the data handling server 130 may output feature maps 340. The data handling server 130 may process the feature maps 340 to determine extracted features 345. For example, for the sliding window 325 denoted above as Xₜ, the extracted features 345 as extracted patterns x̅ₜ may be determined and included in the modified data of the sliding window 325 used as the input for the prediction model to output a prediction to fill the data gap 320. The extracted features 345 may be based on maximum values and a proportion of positive values (ppv) that measure a proportion of the input that matches a given pattern which results in improved performance over average pooling. In an exemplary implementation, for k kernels, 2k features may be extracted. In this manner, the extracted features may fill the data gap 320 by forecasting the missing values in the data gap 320 at the corresponding timestamp.

As those skilled in the art will understand, the exemplary embodiments provide a plurality of features that provide improved performance in handling data gaps. In using a sliding window to forecast the data gaps, the exemplary embodiments may make full use of all available data as extracted patterns are used rather than relying on assumptions or omissions. The exemplary embodiments may also capture the interactions across multi-variables spanning the sliding window. The exemplary embodiments are also flexible to fit different scenarios without prior assumptions. In using the ROCKET algorithm over the sliding window, the exemplary embodiments may extract patterns across multi-variables and different timestamps while learning patterns by masking the missingness due to the window data gaps in the dependent data. The exemplary embodiments are also flexible to be adapted to other applications with inconsistent lengths of input. For example, the exemplary embodiments may artificially insert data gaps to create a substantially consistent length of input and the missingness of these artificial data gaps may be compensated through the extracted patterns determined via the ROCKET algorithm.

The exemplary embodiments are configured to handle data gaps in sequential data by filling in a selected data gap through a selective process. In scenarios where a sliding window from which information is used to fill the selected data gap also has at least one data gap, the exemplary embodiments utilize an algorithm to mask the data gaps in the data of the sliding window by extracted patterns. In this manner, the data fed to a prediction model to fill the selected gap may be modified data from the actual data of the sliding window through the inclusion of the extracted patterns. Therefore, the exemplary embodiments may utilize all available information that has been received in filling in data gaps in a manner that is flexible and easily adaptable to a variety of systems that process sequential data.

FIG. 4 depicts a block diagram of devices within the data gap filling system 100 of FIG. 1, in accordance with the exemplary embodiments. It should be appreciated that FIG. 4 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, RAY drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and the exemplary embodiments are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data gap processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for handling a data gap in sequential data, the method comprising:
receiving the sequential data for a period of time;
selecting the data gap in the sequential data, the data gap being at a timestamp;
determining a sliding window associated with the data gap, the sliding window being based on the timestamp for a duration of time preceding the timestamp, the sliding window including dependent data indicative of information that the data gap depends;
as a result of the dependent data of the sliding window including at least one window data gap, generating extracted patterns based on the dependent data to mask the at least one window data gap; and
determining a prediction to fill the data gap using a prediction model that takes as input modified data based on the dependent data and the extracted patterns.

2. The computer-implemented method of claim 1, wherein the extracted patterns are generated based on a random convolutional kernel transform algorithm.

3. The computer-implemented method of claim 2, wherein the random convolutional kernel transform algorithm is a multi-variate time-series classification model.

4. The computer-implemented method of claim 2, wherein the random convolutional kernel transform algorithm performs a convolution with kernels on the dependent data to generate feature maps from which extracted features may be determined, the extracted features corresponding to the extracted patterns.

5. The computer-implemented method of claim 1, wherein the duration of time of the sliding window immediately precedes the timestamp.

6. The computer-implemented method of claim 1, further comprising:
validating the prediction based on an acceptable threshold for subsequent processing of the sequential data with the prediction; and
as a result of the prediction not being validated, performing a feedback by determining a modified operation in determining a further prediction.

7. The computer-implemented method of claim 6, wherein the modified operation is one of using a different feature extraction method, using a different method for prediction, and estimating at least one of a floor and ceiling accuracy.

8. A non-transitory computer-readable storage media that configures a computer to perform program instructions stored on the non-transitory computer-readable storage media for handling a data gap in sequential data, the program instructions comprising:
receiving the sequential data for a period of time;
selecting the data gap in the sequential data, the data gap being at a timestamp;
determining a sliding window associated with the data gap, the sliding window being based on the timestamp for a duration of time preceding the timestamp, the sliding window including dependent data indicative of information that the data gap depends;
as a result of the dependent data of the sliding window including at least one window data gap, generating extracted patterns based on the dependent data to mask the at least one window data gap; and
determining a prediction to fill the data gap using a prediction model that takes as input modified data based on the dependent data and the extracted patterns.

9. The non-transitory computer-readable storage media of claim 8, wherein the extracted patterns are generated based on a random convolutional kernel transform algorithm.

10. The non-transitory computer-readable storage media of claim 9, wherein the random convolutional kernel transform algorithm is a multi-variate time-series classification model.

11. The non-transitory computer-readable storage media of claim 9, wherein the random convolutional kernel transform algorithm performs a convolution with kernels on the dependent data to generate feature maps from which extracted features may be determined, the extracted features corresponding to the extracted patterns.

12. The non-transitory computer-readable storage media of claim 8, wherein the duration of time of the sliding window immediately precedes the timestamp.

13. The non-transitory computer-readable storage media of claim 8, wherein the program instructions further comprise:
validating the prediction based on an acceptable threshold for subsequent processing of the sequential data with the prediction; and
as a result of the prediction not being validated, performing a feedback by determining a modified operation in determining a further prediction.

14. The non-transitory computer-readable storage media of claim 13, wherein the modified operation is one of using a different feature extraction method, using a different method for prediction, and estimating at least one of a floor and ceiling accuracy.

15. A computer system for handling a data gap in sequential data, the computer system comprising:
one or more computer processors, one or more computer-readable storage media, and program instructions stored on the one or more of the computer-readable storage media for execution by at least one of the one or more processors capable of performing a method, the method comprising:
receiving the sequential data for a period of time;
selecting the data gap in the sequential data, the data gap being at a timestamp;
determining a sliding window associated with the data gap, the sliding window being based on the timestamp for a duration of time preceding the timestamp, the sliding window including dependent data indicative of information that the data gap depends;
as a result of the dependent data of the sliding window including at least one window data gap, generating extracted patterns based on the dependent data to mask the at least one window data gap; and
determining a prediction to fill the data gap using a prediction model that takes as input modified data based on the dependent data and the extracted patterns.

16. The computer system of claim 15, wherein the extracted patterns are generated based on a random convolutional kernel transform algorithm.

17. The computer system of claim 16, wherein the random convolutional kernel transform algorithm is a multi-variate time-series classification model.

18. The computer system of claim 16, wherein the random convolutional kernel transform algorithm performs a convolution with kernels on the dependent data to generate feature maps from which extracted features may be determined, the extracted features corresponding to the extracted patterns.

19. The computer system of claim 15, wherein the duration of time of the sliding window immediately precedes the timestamp.

20. The computer system of claim 15, wherein the method further comprises:
validating the prediction based on an acceptable threshold for subsequent processing of the sequential data with the prediction; and
as a result of the prediction not being validated, performing a feedback by determining a modified operation in determining a further prediction.
